(19) United States
(12) Patent Application Publication
(10) Pub. No.: US 2026/0318082 A1
(43) Pub. Date: Oct. 15, 2026

(54) RAMP ELEMENT WITH REINFORCED CUTTING GROOVE AND METHOD FOR CUSTOMIZING THE WIDTH OF THE RAMP ELEMENT

(71) Applicant: Excellent Holding ApS, Mørke (DK)

(72) Inventor: Ole Frederiksen, Hornslet (DK)

(21) Appl. No.: 19/642,786

(22) Filed: Apr. 9, 2026

(30) Foreign Application Priority Data
Apr. 11, 2025 (DK) PA 2025 30221

(51) Int. Cl. E04F 11/00

(52) U.S. Cl. CPC E04F 11/002

(57) ABSTRACT

A ramp element for a modular ramp system and a method for customizing the width of the ramp element is provided. The ramp element includes a bottom surface extending along a width and a depth, a top surface inclining at an angle relative to the bottom surface, and at least one cutting groove for customizing a width of the ramp element. The cutting groove extends from a ramp end towards a front edge in a substantially right angle, and comprises oppositely arranged groove walls, a groove apex connecting the two groove walls, and at least one transverse wall reinforcement arranged between the oppositely arranged groove walls.

### CROSS REFERENCE TO RELATED APPLICATIONS

This application claims priority to Danish Application No. PA 2025 30221, having a filing date of Apr. 11, 2025, the entire contents of which is hereby incorporated by reference.

### FIELD OF TECHNOLOGY

The following relates to a ramp element for a modular ramp system and a method for customizing the width of the ramp element.

### BACKGROUND

The ramp element comprises a bottom surface extending along a width and a depth, a top surface inclining at an angle relative to the bottom surface, and at least one cutting groove for customizing a width of the ramp element.

The cutting groove extends from a ramp end towards a front edge and comprises oppositely arranged groove walls, a groove apex connecting the groove walls, and at least one transverse wall reinforcement arranged between the oppositely arranged groove walls.

Ramps are known in the art for assisting users of mobility aids, such as wheelchairs or rollators, or transport vessels such as wagons, trollies, forklifts, pallet trucks, or small vehicles, in crossing an obstacle.

The term ‘obstacle’ may in this context be used to describe the object that a ramp or a ramp system is assisting a user in overcoming. Relevant obstacles may be doorsteps, level differences between two surfaces e.g., floors, steps, stairs, outdoor or indoor.

The customization of ramps to be adapted to different obstacle widths, e.g., different widths of doorsteps, are currently either very labor intensive or require a vast amount of casting molds to cater to different needs. Casting molds are very expensive and consequently, there is a need to limit the amounts of molds needed and thus to make the process of customizing the widths of ramp elements simpler.

Other ramps of the conventional art are extruded as triangular profiles, however, to enable customization of the widths, the extruded profiles are subsequently subjected to a manual grooving process. During this process, grooves are milled from the bottom of the ramp using tools such as a saw. This, however, is very labor intensive and greatly weakens the stability of the ramp. Furthermore, the resulting ramp is both very heavy, limp, and unstable ramp, that is very difficult to handle during installation.

US 2023/0026263 A1 discloses one example of a stackable vehicle ramp made in light weight material. The ramp comprises internal structure for enhanced structural strength for supporting vehicles while being stackable and lightweight. However, the stackable ramp is not a modular ramp system adaptable for different obstacle widths.

There is thus a need for providing a ramp element for a modular ramp system with the aim of overcoming the challenges of present width customization of ramps.

### SUMMARY

An aspect relates a stabile ramp element which can easily be customized to a desired width.

Another aspect is to achieve a method of customizing the width of the ramp element.

An aspect of embodiments of the invention is achieved by a ramp element for a modular ramp system.

The ramp element comprises:
a bottom surface extending along a width and a depth;
a top surface inclining at an angle relative to the bottom surface, wherein the bottom surface and the top surface is connected along a front edge forming an acute angle, and wherein a back edge forms an apex defining an end ramp height H;
a ramp end connecting the bottom surface and the back edge; and
at least one cutting groove for customizing a width of the ramp element.

The cutting groove extends from the ramp end towards the front edge at a substantially right angle. and the cutting groove comprises:
oppositely arranged groove walls;
a groove apex connecting the two groove walls; and
at least one transverse wall reinforcement arranged between the oppositely arranged groove walls.

The back edge and the ramp end may form an acute angle between the top surface and the ramp end, which consequently results in an obtuse angle between the ramp end and the bottom surface. One advantage of the acute angle between the top surface and the ramp end, may be to ensure that the back edge of the ramp sits flush with the top of the obstacle of which the ramp is arranged to overcome, even with the presence of a shoe molding. Consequently, the gab between the back edge and the top of the obstacle is minimized.

The ramp element may comprise between 1 and 10 cutting grooves, desirably 2-6, and more desirably 3-5. The cutting grooves may be arranged in intervals ensuring that the most commonly used widths can be achieved, e.g., widths corresponding to commonly used standard widths of doors.

Each cutting groove may comprise 1-10 transverse wall reinforcements, desirably 2-7, and more desirably 3-5.

One advantage of the reinforcement may be increasing stability in the direction of the width while allowing the width of the ramp to be easily customized, thereby achieving a modular ramp system which is a width adjustable system i.e. customizable in width.

At least part of the inclined top surface may comprise anti-slip elements. The anti-slip elements may be a coating, such as rubber, or a rough surface, embossed elements, to increase the friction. Anti-slip elements may prevent users of the ramp to slip when crossing the ramp.

One advantage of the width of the ramp being customizable, may be saving cost on production. For ramp elements that are mold, one mold with cutting grooves may be used to make ramp elements that can be customized to a variety of widths, thus limiting the number of molds required to make ramp elements of a predetermined end height and depth but are usable for a variety of widths.

The cutting grooves may weaken the ramp element in the direction along the width, which may result in a limp structure, however, the transverse wall reinforcement is provided to overcome this problem.

One advantage of at least one transverse wall being arranged in the cutting grooves, may be achieving increased stability of the ramp element.

In embodiments, the transverse wall may have a wall thickness of 0.3-7 mm to provide an increased stability in the direction along the width of the ramp. The thickness may further make it easier to break the transverse wall when customizing the width of the ramp element.

Breaking the transverse wall may be used to describe any destabilizing the cutting groove by manipulating the transverse wall, e.g., by cutting, sawing, applying force, milling, using forceps, etc.

A further advantage of the wall thickness of 0.3-7 mm is that the transverse wall may be broken by using a utility knife to cut the walls. Using only a utility knife to customize the width of the ramp element may make the process very secure and thus may limit the risk of injury. Additionally, the process of customizing may become very simple, fast, and easy as no specialist tools may be required.

The cutting groove may provide an opening in the ramp edge. One advantage of the cutting groove providing an opening in the ramp end, may be that it is easier to bend the ramp element after breaking the transverse wall reinforcements.

The external surface of the ramp element may have a greater thickness than internal walls, e.g., transverse walls, or internally shelled parts, and thus make bending more difficult if part of the external surface of the ramp end has to be broken before the width can be customized.

In an embodiment of the ramp element, the at least one cutting groove may be arranged in the bottom surface.

One advantage of the cutting groove being arranged in the bottom surface may be that the cutting groove is not visible when the ramp element is installed as a ramp or in a ramp system. Thus, by placing the cutting grooves in the bottom surface, the top surface may appear as a single ramp disregarding whether or not the width of the ramp element has been customized. Consequently, a single ramp element having a predetermined end height and a depth can be used for obstacles, such as door openings, of different widths.

A further advantage of the cutting groove being arranged in the bottom surface may be preventing that dirt and dust can be collected in the cutting groove.

In an embodiment of the ramp element, the cutting groove may extend upwards towards the top surface. The groove apex may have an inclination substantially the same as the inclination of the top surface.

One advantage of the groove apex having an inclination substantially the same as the inclination of the top surface may be to make it easier to customize the width of the ramp element by removing the redundant part of the ramp element. The inclinations being substantially the same may for instance enable the ramp element to be bent along the cutting groove and thus may make it easier to access the groove apex to cut off the redundant part of the ramp element.

The vertical distance between the groove apex and the top surface may be equivalent to between 1-25% of the end height of the ramp element as defined by the distance from the back edge to the ground.

The smaller the distance between the groove apex and the top surface, the easier it may be to customize the width of the ramp element.

The transverse walls may cover at least part of the cutting groove. One advantage achieved by the transverse walls covering only part of the cutting groove may be ensuring that the walls may easily be broken, e.g., by cutting using a utility knife.

In an embodiment of the ramp element, the distance between the oppositely arranged groove walls may decrease towards the top surface or towards the back edge.

One advantage of the distance between the oppositely arranged groove walls decreasing towards the top surface, may be to make it easier to customize the width of the ramp element by removing the redundant part of the ramp element.

As the distance between the groove wall decreases, the resulting groove apex may be narrow in the direction along the width of the ramp element and be elongated in the direction along the depth of the ramp element. Consequently, the narrower the groove apex is, because of the decreased distance between the groove walls, the easier it may be to customize the width as the ramp element may be bent along the cutting groove in a more controlled and thus more precise manner. Furthermore, a narrow groove apex may make it easier to cut a straight line in the cutting groove.

In an embodiment of the ramp element, the at least one transverse wall may extend in a direction substantially along the width of the ramp element or parallel to the front edge. This may provide the advantage of increasing the stability of the cutting grooves and thus of the ramp element as a whole. Additionally, the transverse walls extending in the direction along the width, may make it easier to handle the ramp element during installation by preventing torsion and a limp element.

In an embodiment of the ramp element, the at least one transverse wall may extend in a direction substantially perpendicular to the bottom surface. The at least one transverse wall may extend in a direction substantially towards the back edge.

This may provide the advantage of increasing the stability of the cutting grooves and thus of the ramp element as a whole. Additionally, the transverse walls extending in the direction substantially perpendicular to the bottom surface, may make it easier to handle the ramp element during installation by preventing torsion and a limp element.

An additional advantage may be achieved by the transverse walls extending both in a direction along the width and in a direction substantially perpendicular to the bottom surface by further increasing the stability, minimizing torsion, preventing a limp ramp element, and making it easier to handle.

In an embodiment of the ramp element, the bottom surface may comprise a plurality of locking apertures each configured for receiving a locking element. The locking apertures may extend upwards in a direction towards the top surface.

The locking elements may be inserted from the bottom surface to releasably interlock the ramp element with another element within a modular ramp system. The other element may be a wedge element to raise the final end height of the ramp element and thus customize the end height.

In an embodiment of the ramp element, the bottom surface may comprise ramp mounts for releasably attaching to a floor mount.

The floor mount may be a floor lock of the modular ramp system. The floor lock may be attached to the floor using fastening means such as adhesive, screws, etc.

The floor mount may be a mounting tape especially adapted to be releasably attached to the ramp mounts.

The ramp mounts may ensure that the ramp stays in place at a fixed position relative to the obstacle to overcome using the ramp element or ramp system.

The floor mount may be attached along the obstacle, e.g., along a doorstep.

In an embodiment, the ramp element may be molded.

In an embodiment, the ramp element is molded in an injection molding process.

One advantage of molding the ramp element is that the grooves may be molded from the beginning and thus obliviate the need for manually milling or sawing the cutting grooves in a separate process step.

One additional advantage of molding the ramp element may be that it is possible to mold the ramp as a monolith with all the required features present from the start. Thus, the casting mold may enable one or more of the following features to be molded within the ramp element: the cutting grooves, transverse walls, ramp mounts, apertures, anti-slip element in the top surface, embossed or debossed information identifying e.g., size and height of the ramp element.

The ramp element may be constructed in polyethylene.

One advantage of constructing the ramp element in polyethylene may be achieving a non-toxic, PVC-free, odourless, recyclable, acid-resistant, and corrosion resistant ramp element.

The ramp element may be constructed in polyethylene by an injection molding process, however, any polymer molding materials suitable for injection molding may be used.

In an embodiment, the ramp element may be molded as a shell element with the transverse walls.

The thickness of the shelled element, may be 0.3-7 mm.

One advantage of the ramp element being a shelled element is achieving both a lightweight ramp, which is easy to handle during installation, and a highly stable ramp with the ability to withstand heavy loads without deformation.

One additional advantage may be that the shelled element is easily molded using an injection molding process and thus preventing sink holes.

Another aspect of embodiments of the invention is achieved by method of customizing the width of a ramp element.

In embodiments, the method comprises acts of:
providing a ramp element;
breaking the at least one transverse wall reinforcement in the cutting groove corresponding to the desired width of the ramp element;
bending the ramp element at the cutting groove;
cutting the ramp element in the cutting groove to achieve a ramp element with a customized width and discarding a redundant part of the ramp element.

The advantages of embodiments of the method may be substantially the same as the advantages described in relation to the ramp element.

The act of bending the ramp element may be performed by:
arranging the ramp element on a surface, such as a table, with the top surface facing the tabletop;
arranging the elongated part of the cutting groove substantially collinear with an edge of the tabletop; and
arranging the redundant part of the ramp element over the edge of the table.

Alternatively, the ramp element may be arranged with the top surface facing downwards with the elongated part of the cutting groove arranged substantially collinear with a knee or a support horse for easy bending.

After bending, the redundant part of the ramp element may be finally cut off and the edge finished using a knife or sandpaper.

In an aspect of embodiments of the method, the act of breaking the reinforcement and/or the act of bending may be unnecessary. Thus, the ramp element may be cut along one of the cutting grooves by cutting using a knife, sawing, milling, or a similar process.

### BRIEF DESCRIPTION

Some of the embodiments will be described in detail, with references to the following Figures, wherein like designations denote like members, wherein:

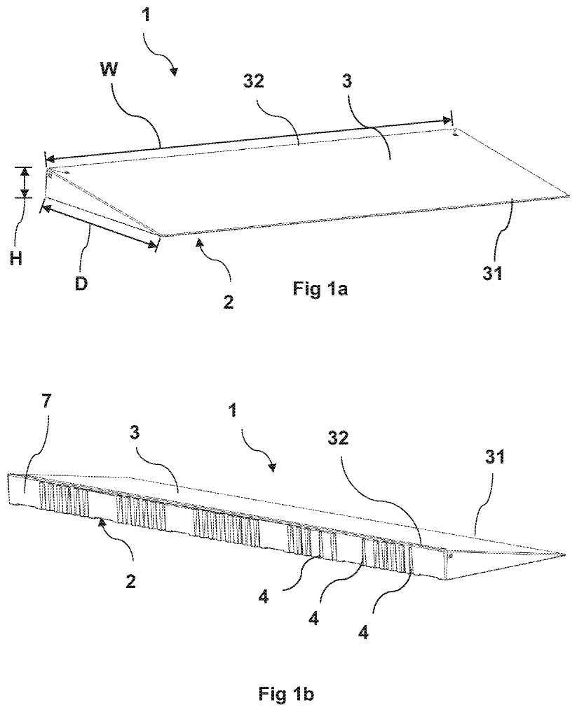

FIG. 1a illustrates a ramp element according to an embodiment of the invention;

FIG. 1b illustrates a ramp element;

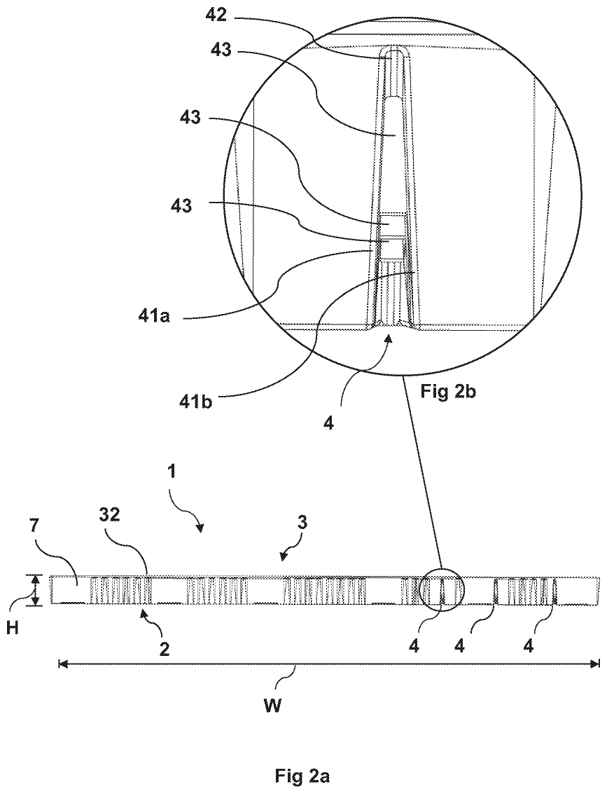

FIG. 2a illustrates an embodiment of the cutting groove of FIG. 1;

FIG. 2b illustrates an embodiment of the cutting groove of FIG. 1;

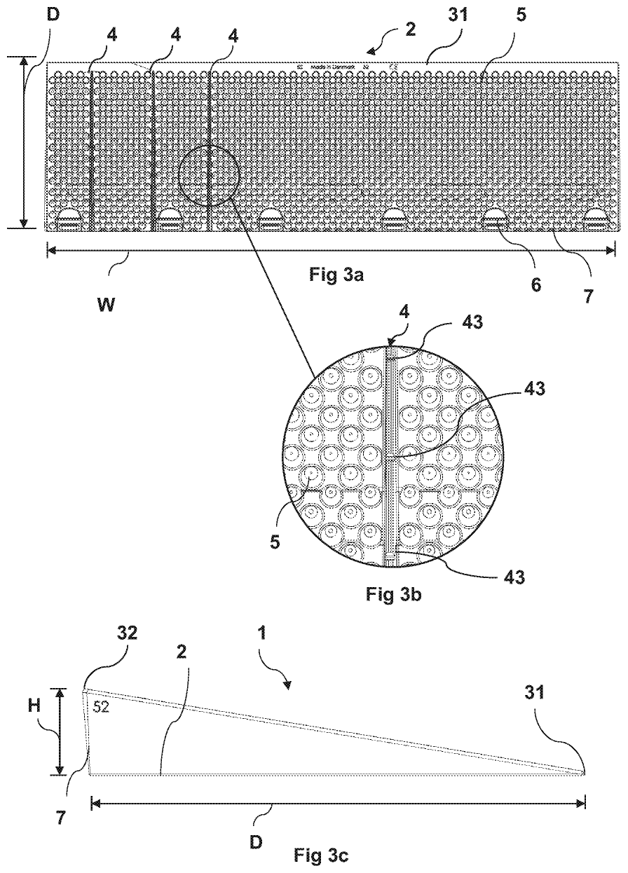

FIG. 3a illustrates the ramp element of FIG. 1;

FIG. 3b illustrates an exploded view of the ramp element of FIG. 3a;

FIG. 3c illustrates the ramp element of FIG. 1;

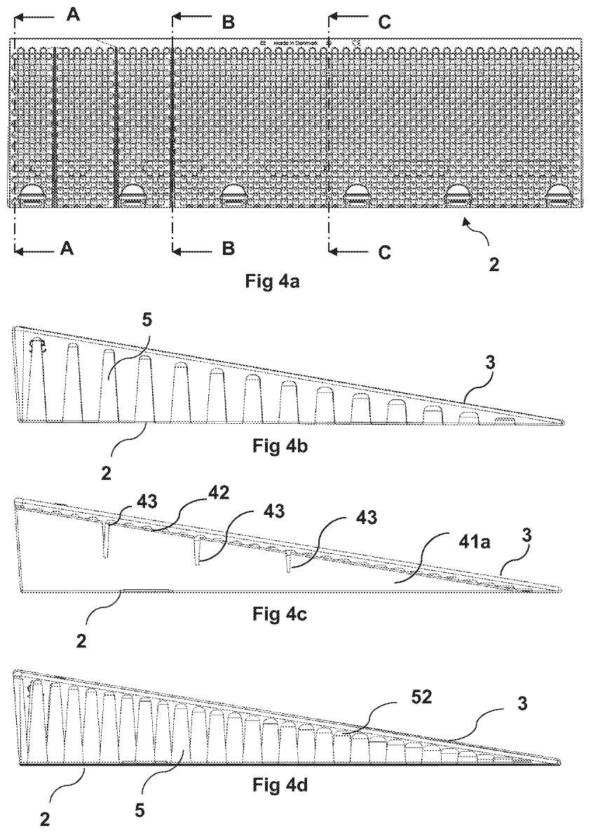

FIG. 4a illustrates the three section cuts of the ramp element;

FIG. 4b shows a cutaway view of A-A of FIG. 4;

FIG. 4c shows a cutaway view of B-B of FIG. 4;

FIG. 4d shows a cutaway view of C-C of FIG. 4;

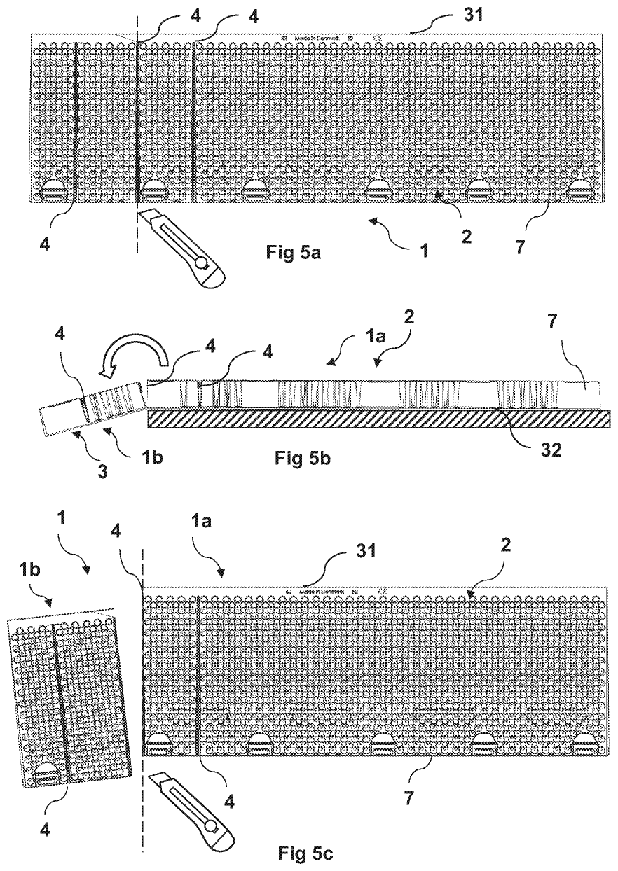

FIG. 5a illustrates a method of customizing the width of the ramp element;

FIG. 5b illustrates a method of customizing the width of the ramp element; and

FIG. 5c illustrates a method of customizing the width of the ramp element.

### DETAILED DESCRIPTION

Exemplary examples will now be described more fully hereinafter with reference to the accompanying drawings. In this regard, the present examples may have different forms and should not be construed as being limited to the descriptions set forth herein. Accordingly, the examples are merely described below, by referring to the figures, to explain aspects.

Throughout the specification, when an element is referred to as being “connected” to another element, the element is “directly connected” to the other element, “electrically connected”, “fluidic connected” or “communicatively connected” to the other element with one or more intervening elements interposed there between.

The terminology used herein is for the purpose of describing particular examples only and is not intended to be limiting. As used herein, the terms “comprises” “comprising” “includes” and/or “including” when used in this specification specify the presence of stated features, integers, steps, operations, elements, and/or components, but do not preclude the presence or addition of one or more other features, integers, steps, operations, elements, components, and/or groups thereof.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined in the present specification.

LIST OF REFERENCE NUMBERS

| No. | Item |
|---|---|
| 1 | Ramp element |
| 1A | Ramp element with a customized width |
| 1B | Redundant part of ramp element |
| 2 | Bottom surface |
| 3 | Top surface |
| 31 | Front edge |
| 32 | Back edge |
| 4 | Cutting groove |
| 41A, 41B | Oppositely arranged groove walls |
| 42 | Groove apex |
| 43 | Transverse wall |
| 5 | Locking apertures |
| 6 | Ramp mounts |
| 7 | Ramp end |
| D | Depth |
| H | End ramp height |
| W | Width |

FIGS. 1a-4c illustrate the ramp element for a modular ramp system according to embodiments of the invention, as seen from different directions and in different configurations.

The ramp element 1 comprises a bottom surface 2 extending along a width W and a depth D.

The ramp element 1 comprises a top surface 3 inclining at an angle relative to the bottom surface 2. The bottom surface 2 and the top surface 3 are connected along a front edge 31 forming an acute angle. A back edge 32 forms an apex defining an end ramp height H.

The ramp element 1 comprises a ramp end 7 connecting the bottom surface 2 and the back edge 32.

The ramp element 1 comprises at least one cutting groove 4 for customizing a width

W of the ramp element 1. The cutting groove 4 extends from the ramp end 7 towards the front edge 31 at a substantially right angle, as best seen in FIGS. 3a, 3b, 4, and 4 (B-B)

As illustrated in FIGS. 2b and 4 (B-B), the cutting groove 4 comprises oppositely arranged groove walls 41a,41b; a groove apex 42 connecting the two groove walls 41a,41b; and at least one transverse wall 43 reinforcement arranged between the oppositely arranged groove walls 41a,41b.

In the illustrated embodiments, the ramp system 1 comprises three cutting grooves 4, each comprising three transverse walls 43. However, in other embodiments, the ramp element may comprise a different amount of cutting grooves 4 and each cutting groove 4 may comprise a different amount of transverse walls 43.

As an example, the ramp element 1 may comprise between 1 and 10 cutting grooves 4, desirably 2-6, and more desirably 3-5. Each cutting groove 4 may comprise 1-10 transverse wall 43 reinforcements, desirably 2-7, and more desirably 3-5.

The figures all illustrate an advantageous embodiment of the ramp element 1, wherein the cutting groove 4 is arranged in the bottom surface 2. In embodiments (not illustrated) the cutting groove 4 may be arranged in the top surface 3.

In the illustrated embodiments, the cutting groove 4 extends upwards towards the top surface 3, see FIG. 2b, and the groove apex 42 has an inclination substantially the same as the inclination of the top surface 3, see FIG. 4c (B-B).

As illustrated in FIG. 2b, the distance between the oppositely arranged groove walls 41a,41b may decrease towards the top surface 3. In an embodiment, the groove walls 41a,41b may decrease towards the back edge 32.

FIGS. 2a and 2b further illustrates that each of the cutting grooves 4 provides an opening in the ramp end 7.

As illustrated the at least one transverse wall 43 may extend in a direction substantially along the width W of the ramp element 1. In an embodiment, the at least one transverse wall 43 may extend in a direction substantially parallel to the front edge 31.

The at least one transverse wall 43 may extend in a direction substantially perpendicular to bottom surface 2. In an embodiment, the at least one transverse wall 43 may extend in a direction substantially towards the back edge 32.

The transverse walls 43 may extend substantially in the cutting groove 4 from the groove apex 42 to the bottom surface 2.

In the embodiment illustrated in FIGS. 2b and 4 (B-B), the transverse walls 43 extend from the groove apex 42 towards the bottom surface 2. Each transverse wall 43 has a transverse wall height of substantially half of the vertical distance from the groove apex 42 to the bottom surface 2. Consequently, as the top surface 3 inclines at an angle relative to the bottom surface 2 so does the groove apex 42 and the three illustrated transverse walls 43 thus having different transverse wall heights and different vertical distances from the bottommost part of the transverse wall 43 to the bottom surface.

As best illustrated in FIGS. 3a and 3b, the bottom surface 2 may comprise a plurality of locking apertures 5 each configured for receiving a locking element. The locking apertures 5 as best seen in FIG. 4(A-A), and 4(C-C), extend upwards in a direction towards the top surface 3. The illustrated locking apertures 5 are substantially cone shaped. The cone shape may provide an advantage when molding a ramp element 1, e.g., in an injection molding process. The cone shape may further make it easier to insert a locking element as the slanted walls guide the locking element to the correct position and only fits tightly around the locking element when positioned substantially in a final locking position.

The bottom surface 2 of the ramp element 1 may further comprise ramp mounts 6 for releasably attaching to a floor mount, as best seen in FIG. 3a.

The ramp element 1 may be molded and may further be molded as a shell element with the transverse wall 43 reinforcements as seen in sections A-A, B-B, and C-C of FIG. 4a, FIG. 4b, FIG. 4c and FIG. 4d.

FIG. 5 illustrates a method of customizing the width W of a ramp element 1 of embodiments of the claimed invention.

In embodiments, the method comprises an act of providing a ramp element 1;

In embodiments, the method comprises an act of breaking the at least one transverse wall 43 reinforcement in the cutting groove 4 corresponding to the desired width of the ramp element 1, as illustrated in FIG. 5a. In the illustrated embodiment, a utility knife is used to break the reinforcement by cutting the transverse walls 43.

In embodiments, the method comprises an act of bending the ramp element 1 at the cutting groove 4, as illustrated in FIG. 5b. As illustrated, the ramp element 1 is bent while the top surface 3 is facing the tabletop. The ramp element 1 is further arranged with the elongated part of the cutting groove 4 substantially collinear with an edge of the tabletop with the redundant part of the ramp element 1b being arranged over the edge of the tabletop. The arrow indicates the movement of bending the ramp element 1 over the edge of the table, however the ramp element 1, here the redundant part 1b, may be bent both downwards (as illustrated) and upwards (not illustrated).

In embodiments, the method comprises an act of cutting the ramp element 1 in the cutting groove 4 to achieve a ramp element with a customized width 1a and to discard a redundant part of the ramp element 1b, as illustrated in FIG. 5c. Thus, finally cutting off the redundant part 1b. Afterwards, the remaining edge on the customized ramp element 1a may be cleaned and/or finished using a knife and/or sandpaper.

In an aspect of embodiments of the method (not illustrated), the act of breaking the transverse wall 43 reinforcement and/or the act of bending may be unnecessary. Thus, the ramp element 1 may be cut along one of the cutting grooves 4 by cutting using a knife, sawing, milling, or a similar process.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A ramp element for a width adjustable modular ramp system, comprising:
a bottom surface extending along a width and a depth;
a top surface inclining at an angle relative to the bottom surface, wherein the bottom surface and the top surface are connected along a front edge forming an acute angle, and wherein a back edge forms an apex defining an end ramp height;
a ramp end connecting the bottom surface and the back edge; and
at least one cutting groove for customizing a width of the ramp element wherein the cutting groove extends from the ramp end towards the front edge at a substantially right angle, and the cutting groove comprises:
oppositely arranged groove walls;
a groove apex connecting the groove walls; and
at least one transverse wall reinforcement arranged between the oppositely arranged groove walls.

2. The ramp element according to claim 1, wherein the at least one cutting groove is arranged in the bottom surface.

3. The ramp element according to claim 1, wherein the cutting groove extends upwards towards the top surface and the groove apex has an inclination substantially the same as the inclination of the top surface.

4. The ramp element according to claim 1, wherein the distance between the oppositely arranged groove walls decreases towards the top surface or towards the back edge.

5. The ramp element according to claim 1, wherein the at least one transverse wall extends in a direction substantially along the width of the ramp element or parallel to the front edge.

6. The ramp element according to claim 1, wherein the at least one transverse wall extends in a direction substantially perpendicular to the bottom surface.

7. The ramp element according to claim 1, wherein the bottom surface comprises a plurality of locking apertures each configured for receiving a locking element, wherein the locking apertures extend upwards in a direction towards the top surface.

8. The ramp element according to claim 1, wherein the bottom surface comprises ramp mounts for releasably attaching to a floor mount.

9. The ramp element according to claim 1, wherein the ramp element is molded.

10. The ramp element according to claim 9 is molded as a shell element with the transverse walls.

11. A method of customizing the width of a ramp element according to claim 1, wherein the method comprises acts of:
providing a ramp element;
breaking the at least one transverse wall reinforcement in the cutting groove corresponding to the desired width of the ramp element;
bending the ramp element at the cutting groove;
cutting the ramp element in the cutting groove to achieve a ramp element with a customized width and discarding a redundant part of the ramp element.
